(19) United States
(12) Patent Application Publication
(10) Pub. No.: US 2013/0234855 A1
(43) Pub. Date: Sep. 12, 2013

(54) HAND SANITIZER DISPENSER AND TRACKING SYSTEM

(71) Applicant: Shanina Knighton, Euclid, OH (US)

(72) Inventor: Shanina Knighton, Euclid, OH (US)

(21) Appl. No.: 13/796,027

(22) Filed: Mar. 12, 2013

Related U.S. Application Data
(60) Provisional application No. 61/685,107, filed on Mar. 12, 2012.

(51) Int. Cl. G08B 23/00; G06F 19/00

(52) U.S. Cl. CPC G06F 19/327
USPC 340/573.1; 222/27

(57) ABSTRACT

A hand sanitizer dispenser and/or system may include a means for dispensing hand sanitizer. It may also include a microprocessor adapted to control electronic components of the hand sanitizer dispenser. A counter may communicate with the dispensing means and may count actuation events thereof. They dispenser and/or system may also include a means for identifying a user of the dispenser, and may be adapted to correlate actuation events with a user and record the data in a data storage means. The dispenser and/or system may also include a data port which may be in communication with a remote computer, and may communicate data recorded by the dispenser to the remote computer.

### I. CROSS REFERENCE TO RELATED APPLICATIONS

This application claims priority to U.S. Provisional Patent Application No. 61/685,107 filed Mar. 12, 2012 and now pending, and to U.S. Utility patent application Ser. No. 13/068,906 filed Oct. 11, 2011 and now pending, both of which are incorporated herein by reference in their entireties.

### II. BACKGROUND OF THE INVENTION

A. Field of Invention

Some embodiments may generally relate to hand sanitizer devices and/or systems.

B. Description of the Related Art

Poor or inadequate hand washing and/or hand hygiene is known to be problematic in hospital settings, and is a major source of infections contracted while patients are admitted to a hospital. While hand washing and hygiene policies and training are important and can be effective in reducing the spread of infections, the problem of infections due to unsatisfactory hygiene of staff, medical professionals, and even patients continues to be problematic. It is known to place hand washing stations and hand sanitizer dispensers throughout medical facilities including in examination rooms, hallways, lobbies, and even patient rooms. However, such systems are purely mechanical and are incapable of providing an automated means of establishing accountability of good hygienic practices.

What is needed is an automated means for establishing accountability for good hygienic practices, and to promote good hygienic habits. Some embodiments of the present invention may provide one or more benefits or advantages over the prior art.

### III. SUMMARY OF THE INVENTION

Some embodiments may relate to a hand sanitizer dispenser, comprising: a means for dispensing hand sanitizer; a microprocessor adapted to control electronic components of the hand sanitizer dispenser; a counter in electronic communication with the means for dispensing, and with the microprocessor, and adapted to count each use of the means for dispensing; an electronic data storage means in electronic data communication with the counter, and with the microprocessor, and adapted to receive count data from the counter and store said count data; a wireless means for reading a user-identifying signal in electronic data communication with the electronic data storage means, wherein the wireless means is adapted to transmit user-identifying data to the electronic data storage means which receives and records said data, and wherein the user-identifying data is correlated to and associated with at least one count of the counter; and a data port adapted to communicate count and user-identifying data to an external computer system.

Embodiments may also include a clock circuit wherein said clock circuit is adapted to provide a time stamp and communicate said time stamp to the electronic data storage means, the time stamp being associated by the microprocessor with a use count.

In some embodiments the wireless means for reading a user-identifying signal comprises an active RFID reader, adapted to read passive RFID tags.

In some embodiments a passive RFID tag is readable by an RFID tag reader on-board the hand sanitizer dispenser when the passive RFID tag is a distance from the RFID tag reader of about 12 inches, 11 inches, 10 inches, 9 inches, 8 inches, 7 inches, 6 inches, 5 inches, 4 inches, 3 inches, 2 inches, and/or 1 inch.

In some embodiments the data port is adapted to communicate count and RFID tag data to a computer network.

In some embodiments the data port is adapted to communicate with an external computer system according to an HL7 compliant data protocol.

Some embodiments may relate to a hygiene system, comprising: a hand sanitizer dispenser adapted to count dispenser actuation events and to associate each actuation event with a time stamp and with a user; a remote server computer adapted to communicate with a microcomputer on-board the hand sanitizer dispenser, and to receive data therefrom comprising hand sanitizer dispenser actuation event counts associated with a time stamp and with a user, wherein the remote server computer is adapted to record the data received from the hand sanitizer dispenser's microcomputer in a database and associate said data with patient-specific data selected from one or more of admittance date, release date, electronic health records, patient name, patient social security number, patient ID number, room number, bed number, attending physician ID, other caregiver ID, visitor ID, visitation dates, diagnoses data, diagnostic test data, treatment regime data, treatment outcome data, prescription data, health insurance data, emergency contact data, or pre-existing conditions data; and a software reporting module adapted to query the database of the remote server computer and compile the query results according to one or more predetermined reporting protocols.

In some embodiments the user is identifiable by the dispenser reading an RFID tag worn by the user.

In some embodiments the RFID tag worn by a user is a passive RFID tag.

In some embodiments the passive RFID tag is readable by an RFID tag reader on-board the hand sanitizer dispenser when the passive RFID tag is a distance from the RFID tag reader of about 12 inches, 11 inches, 10 inches, 9 inches, 8 inches, 7 inches, 6 inches, 5 inches, 4 inches, 3 inches, 2 inches, and/or 1 inch.

In some embodiments data communication between the hand sanitizer dispenser's microcomputer and the remote server computer is according to an HL7 compliant protocol.

Some embodiments may relate to a hygiene system, comprising: a hand sanitizer dispenser including: a means for dispensing hand sanitizer; a microprocessor adapted to control electronic components of the hand sanitizer dispenser; a counter in electronic communication with the means for dispensing, and with the microprocessor, and adapted to count each use of the means for dispensing; an electronic data storage means in electronic data communication with the counter, and with the microprocessor, and adapted to receive count data from the counter and store said count data; an RFID tag reader in electronic data communication with the electronic data storage means, wherein the microprocessor is adapted to instruct the RFID tag reader to transmit RFID tag data to the electronic data storage means which receives and records said data, and wherein the RFID tag data is correlated to and associated with at least one count of the counter; a clock circuit wherein said clock circuit is adapted to provide a time stamp and communicate said time stamp to the electronic data storage means, the time stamp being associated by the microprocessor with a use count; and a data port adapted to communicate count and RFID tag data to an external computer system; a remote server computer adapted to communicate with the microcomputer on-board the hand sanitizer dispenser, and to receive data therefrom comprising hand sanitizer dispenser actuation event counts associated with a time stamp and with a user, wherein the remote server computer is adapted to record the data received from the hand sanitizer dispenser's microcomputer in a database and associate said data with patient-specific data selected from one or more of admittance date, release date, electronic health records, patient name, patient social security number, patient ID number, room number, bed number, attending physician ID, other caregiver ID, visitor ID, visitation dates, diagnoses data, diagnostic test data, treatment regime data, treatment outcome data, prescription data, health insurance data, emergency contact data, or pre-existing conditions data; and a software reporting module adapted to query the database of the remote server computer and compile the query results according to one or more predetermined reporting protocols.

In some embodiments the RFID reader comprises an active RFID reader, adapted to read passive RFID tags.

In some embodiments a passive RFID tag is readable by an RFID tag reader on-board the hand sanitizer dispenser when the passive RFID tag is a distance from the RFID tag reader of about 12 inches, 11 inches, 10 inches, 9 inches, 8 inches, 7 inches, 6 inches, 5 inches, 4 inches, 3 inches, 2 inches, and/or 1 inch.

In some embodiments data communication between the hand sanitizer dispenser's microcomputer and the remote server computer is according to an HL7 compliant protocol.

Other benefits and advantages will become apparent to those skilled in the art to which it pertains upon reading and understanding of the following detailed specification.

### IV. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a schematic diagram of a dispenser according to an embodiment;

FIG. 2 is a schematic diagram of a hand sanitizer system according to an embodiment; and

FIG. 3 is a flowchart of a process which may be carried out by or in association with an embodiment.

### V. DETAILED DESCRIPTION OF THE INVENTION

Embodiments may include a hand sanitizer and/or hand sanitizer system. A dispenser may include a dispensing means, for discharging hand sanitizer from the dispenser according to any of a variety of mechanisms known in the art. A dispenser may also include a microprocessor adapted to control one or more electronic components of the hand sanitizer dispenser. One such electronic component may include a counter or assembly thereof which electronically communicates with the dispensing means and count each actuation event thereof. As used herein, an actuation event includes the action of a mechanism of the dispensing means to dispense hand sanitizer. An actuation event may be interchangeably referred to herein as a use of the dispenser or a use event. A dispenser may also include an electronic data storage means, which may be in electronic data communication with the counter and/or with the microprocessor. The electronic data storage means may operate under the control of the microprocessor and may be adapted to receive and record count data from the counter. A dispenser may also include a means for identifying a user of the dispenser, and may record the user's identity in association with an actuation event. Embodiments may also include a data port adapted to communicate electronically with a remote computer system external the embodiment.

A suitable electronic data storage means can include volatile or nonvolatile means for storing electronic data including, without limitation, magnetic media, hard disk drives, flash memory, random access memory, or even optical disks. One skilled in the art will appreciate that one or more of these media may be appropriate depending on the specific device application, the nature of the data being collected, and other device features or requirements which may be desirable in addition to those set forth herein.

Suitable means for identifying a user may include, without limitation, a radio frequency identification (RFID) tag, a Bluetooth-enabled device, or other wireless signaling means. According to some embodiments, a passive RFID tag may be embedded in a hospital bracelet and may be uniquely encoded to identify an individual such as a patient or medical personnel who may interact with the patient. In some embodiments, the passive RFID tag must be within a predetermined distance from the dispensing means or an actuator thereof so that only the hand of a user in the act of actuating the device will be activated by the RFID tag reader. Such an arrangement may be desirable for ensuring that only an RFID tag of a user in the act of using the dispenser is read by the RFID reader. A suitable distance between of the RFID tag from the dispensing means or an actuator thereof may be between about 12 inches and about 1 inch. Other suitable distances may include one or more of about 12 to 11 inches, 11 to 10 inches, 10 to 9 inches, 9 to 8 inches, 8 to 7 inches, 7 to 6 inches, 6 to 5 inches, 5 to 4 inches, 4 to 3 inches, 3 to 2 inches, or 2 to 1 inches. Here as elsewhere in the specification and claims, ranges may be combined.

Embodiments of the invention may be adapted to record a user identification signal, such as that of an RFID tag, in association with an actuation event count. As used herein the term “in association with” in regard to recording data in electronic media includes structuring the data in such a way that a logical association is created so that a particular actuation event can be accurately attributed to a particular user. Embodiments may include means for correlating an actuation event with a user ID signal as will be apparent to those skilled in the art. For instance, in some embodiments a correlation can be established if an actuation even occurs within a predetermined amount of time of receiving a user-identifying signal such as an RFID reading. Conversely, if an RFID reading is received by an embodiment, but the reading cannot be correlated to an actuation event, then the RFID reading may be disregarded or erased from memory.

Some embodiments may optionally include a feature whereby the dispensing means can only actuate if a user-identifying signal is first received. Alternatively, rather than blocking actuation, an unidentified user may instead receive hand sanitizer in addition to some negative indicia such as a red LED light or buzzer which indicates inappropriate use of the device. Inappropriate uses may or may not be recorded in the electronic data storage means.

As previously stated, embodiments may include a data port for communicating with a remote computer system. As used herein the term remote computer system can include a computer accessible through a network interface connection including, without limitation, Ethernet and/or Wi-Fi; however, a remote computer system may also include a computer which communicates directly or indirectly with a data port such as through USB, serial port, or parallel port connection. For instance, according to this definition, a remote computer system can include a personal computer which connects to an embodiment through a USB, serial, or parallel port, patch cable without the need for a traditional network interface controller such as an Ethernet controller.

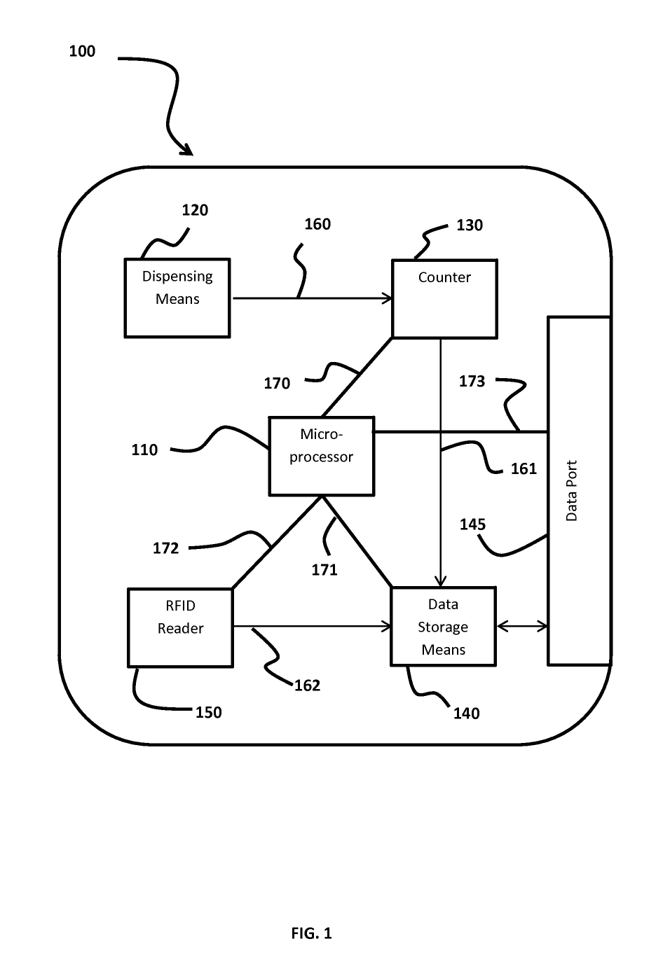

Referring now to the drawings wherein the showings are for purposes of illustrating embodiments of the invention only and not for purposes of limiting the same, FIG. 1 is a schematic diagram of a hand sanitizer dispenser 100 according to one embodiment of the invention. The dispenser 100 of FIG. 1 includes a microprocessor 110 which is in electronic communication 170 with a counter 130. As used herein, the term electronic communication may include electronic data communication, electronic controlling communication, or both. The counter 130 communicates 160 with a dispensing means 120 and is adapted to count each time the dispensing means is actuated, i.e. actuation events. The counter communicates 161 count data to the data storage means 140.

One skilled in the art will appreciate that the count data may be routed through the microprocessor 110 where it may be processed, or the count data may be communicated directly to the data storage means 140 in cooperation with the microprocessor 110. Particularly, one skilled in the art will appreciate that the microprocessor 110 may actually comprise a plurality of cooperating microprocessors wherein electronic components of the dispenser, such as the counter, data storage means, data port and/or RFID reader, may have their own microprocessor(s) which may perform analog-to-digital conversions, signal transformations, or other functions such as clock functions.

Further according to FIG. 1, the microprocessor 110 may include a clock circuit and may cause count data to be associated with a time reference or time stamp to indicate when the count data was produced and/or recorded in the data storage means 140. The dispenser 100 of FIG. 1 also includes an RFID reader 150 adapted to read passive RFID chips, which is in electronic communication 172 with the microprocessor 110. RFID data which is read from a chip may be communicated 162 to the data storage means 140 and may be recorded therein in association with count data to which it correlates. Similar to the counter 130, the RFID reader 150 may be adapted to route its data signal through the microprocessor 110 where it may be processed, or it may be communicated directly to the data storage means 140 in cooperation with the microprocessor 110. Accordingly, the data storage means 140 may include time-stamped count data and user-identifying data which correlates to the count data. Thus, each count can be accurately attributed to a particular user. Finally, the dispenser of FIG. 1 also includes a data port 145 which is in data communication with the data storage means 140 and electronic communication 173 with the microprocessor 110. Data stored in the data storage means 140 may be communicated to computer systems external to the embodiment 100 through the data port 145. Conversely, the embodiment 100 may receive data from external computer systems through the data port 145.

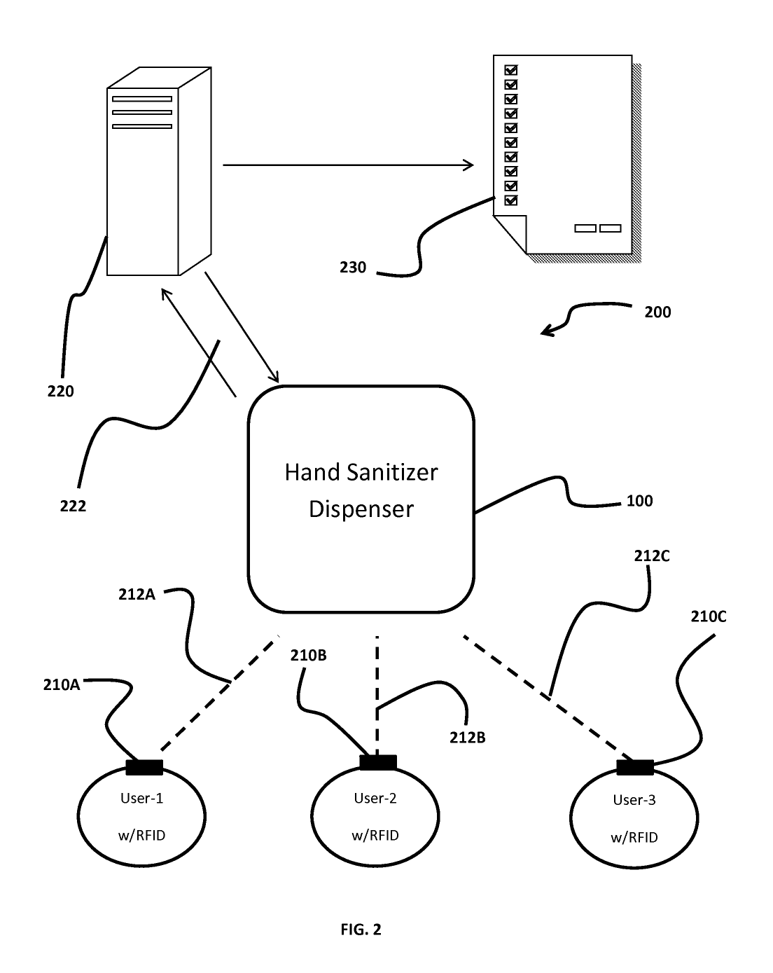

FIG. 2 is a schematic diagram of a hand sanitizer system 200 according to an embodiment. As shown, the hand sanitizer dispenser 100 is in bidirectional communication 222 through the data port 145 with an external computer system 220. Additionally, a plurality bracelets embedded with RFID chips 210A, 210B, 210C are affixed to user-1, user-2, and user-3. Each RFID chip 210A, 210B, 210C is encoded with unique identifying signals 212A, 212B, 212C such that the users can be discerned from one another. When a user attempts to actuate the dispenser 100, he/she reaches toward the dispenser 100 with the hand bearing the RFID bracelet 210A, 210B or 210C which is read by the RFID reader 150 of the dispenser 100. Provided that an actuation event is recorded within a predetermined time thereafter, the RFID signal will be correlated to the actuation event and will be recorded in relation to the actuation event data along with an optional time stamp. The data recorded in this manner may be uploaded to the remote computer system 220 and may be used to generate reports 230 which may assist a medical facility with conceptualizing the data and deriving meaning from it.

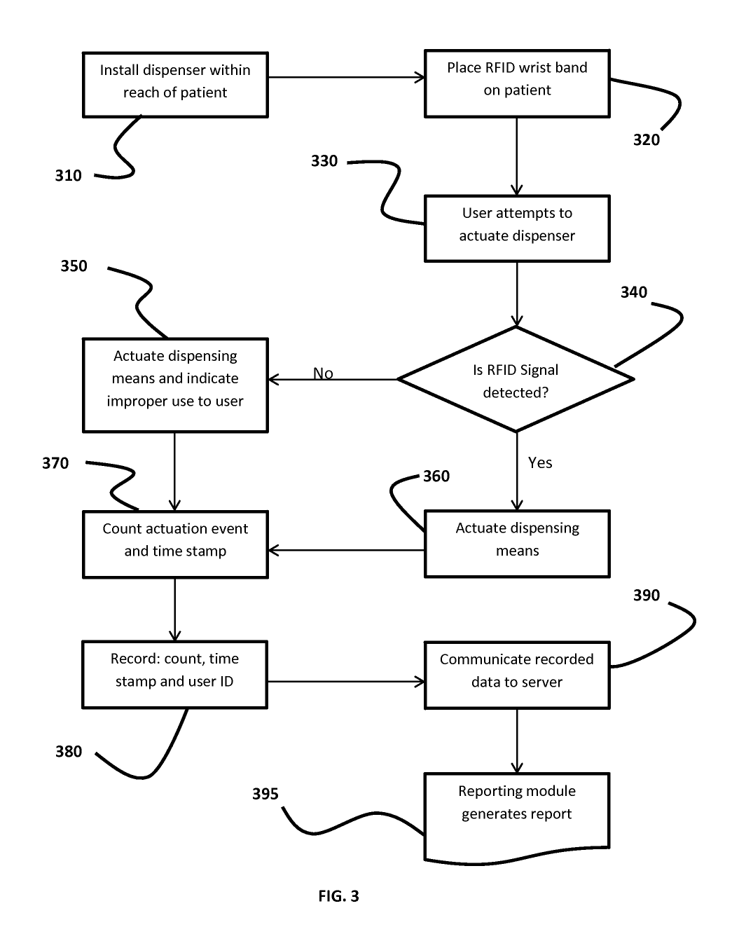

FIG. 3 illustrates a method which may be carried out by, or in association with, an embodiment 100 and/or system 200. According to the method of FIG. 3, a dispenser 100 is installed 310 within reach of a patient. For instance, it may be mounted to the bed side rail, or to a nearby structure within arms reach. An RFID bracelet is placed on the patient, preferably on the wrist most proximal to the dispenser 100. The patient/user then reaches toward the dispenser 10 to actuate the dispenser 100 and receive hand sanitizer, and when the RFID chip is sufficiently near the dispenser 100, it is detected and read 340 by the RFID reader 150 of the dispenser 100, and the dispensing means is actuated 360. The RFID data read by the dispenser 100 may be time stamped. Alternatively, if no RFID signal is detected and/or readable 340 prior to the actuation event then the dispenser 100 produces feedback for the user indicating improper use 350; however, the dispenser 100 still provides hand sanitizer 350 in this particular embodiment. In either case 350 or 360, the actuation event is counted and time stamped 370.

The count data and the RFID data may then be subjected to a correlation protocol to determine whether the actuation event can be accurately attributed to the identified user. For instance, if the system determines that the RFID data was read with an allowable time window relative to the actuation event then the two may be correlated. Suitable time windows may be between about 5000 milliseconds and 5 milliseconds. Other suitable time windows may be between about 5000 and 4000 ms, 4000 and 3000 ms, 3000 and 2000 ms, 2000 and 1000 ms, 1000 and 500 ms, 500 and 100 ms, 100 and 50 ms, 50 and 10 ms, or 10 and 5 ms.

If the actuation event is correlated to a user then the count data and user-identifying data, and optionally one or more time stamps, may be recorded 380 in relation to each other in the data storage means 140. This data may be accumulated and stored onboard the dispenser 100, e.g. in a buffer, or may be transmitted 390 directly to a remote computer system 220 through the data port 145. The data may then be used to produce reports 395.

One skilled in the art will appreciate that embodiments are not limited to hand sanitizer dispensers. Rather, the systems and methods set forth herein can be applied to solve a wide variety of user-accountability problems in the medical and other arts where an actuation event needs to be correlated to the user of a device.

It will be apparent to those skilled in the art that the above methods and apparatuses may be changed or modified without departing from the general scope of the invention. The invention is intended to include all such modifications and alterations insofar as they come within the scope of the appended claims or the equivalents thereof.

Having thus described the invention, it is now claimed:

I/We claim:

1. A hand sanitizer dispenser, comprising:
a means for dispensing hand sanitizer;
a microprocessor adapted to control electronic components of the hand sanitizer dispenser;
a counter in electronic communication with the means for dispensing, and with the microprocessor, and adapted to count each use of the means for dispensing;
an electronic data storage means in electronic data communication with the counter, and with the microprocessor, and adapted to receive count data from the counter and store said count data;
a wireless means for reading a user-identifying signal in electronic data communication with the electronic data storage means, wherein the wireless means is adapted to transmit user-identifying data to the electronic data storage means which receives and records said data, and wherein the user-identifying data is correlated to and associated with at least one count of the counter; and
a data port adapted to communicate count and user-identifying data to an external computer system.

2. The dispenser of claim 1, further comprising a clock circuit wherein said clock circuit is adapted to provide a time stamp and communicate said time stamp to the electronic data storage means, the time stamp being associated by the microprocessor with a use count.

3. The dispenser of claim 1, wherein the wireless means for reading a user-identifying signal comprises an active RFID reader, adapted to read passive RFID tags.

4. The dispenser of claim 1, wherein a passive RFID tag is readable by an RFID tag reader on-board the hand sanitizer dispenser when the passive RFID tag is a distance from the RFID tag reader of about 12 inches, 11 inches, 10 inches, 9 inches, 8 inches, 7 inches, 6 inches, 5 inches, 4 inches, 3 inches, 2 inches, and/or 1 inch.

5. The dispenser of claim 1, wherein the data port is adapted to communicate count and RFID tag data to a computer network.

6. The dispenser of claim 1, wherein the data port is adapted to communicate with an external computer system according to an HL7 compliant data protocol.

7. A hygiene system, comprising:
a hand sanitizer dispenser adapted to count dispenser actuation events and to associate each actuation event with a time stamp and with a user;
a remote server computer adapted to communicate with a microcomputer on-board the hand sanitizer dispenser, and to receive data therefrom comprising hand sanitizer dispenser actuation event counts associated with a time stamp and with a user, wherein the remote server computer is adapted to record the data received from the hand sanitizer dispenser's microcomputer in a database and associate said data with patient-specific data selected from one or more of admittance date, release date, electronic health records, patient name, patient social security number, patient ID number, room number, bed number, attending physician ID, other caregiver ID, visitor ID, visitation dates, diagnoses data, diagnostic test data, treatment regime data, treatment outcome data, prescription data, health insurance data, emergency contact data, or pre-existing conditions data; and
a software reporting module adapted to query the database of the remote server computer and compile the query results according to one or more predetermined reporting protocols.

8. The system of claim 7, wherein the user is identifiable by the dispenser reading an RFID tag worn by the user.

9. The system of claim 8, wherein the RFID tag worn by a user is a passive RFID tag.

10. The system of claim 9, wherein the passive RFID tag is readable by an RFID tag reader on-board the hand sanitizer dispenser when the passive RFID tag is a distance from the RFID tag reader of about 12 inches, 11 inches, 10 inches, 9 inches, 8 inches, 7 inches, 6 inches, 5 inches, 4 inches, 3 inches, 2 inches, and/or 1 inch.

11. The system of claim 7, wherein data communication between the hand sanitizer dispenser's microcomputer and the remote server computer is according to an HL7 compliant protocol.

12. A hygiene system, comprising:
a hand sanitizer dispenser including:
a. a means for dispensing hand sanitizer;
b. a microprocessor adapted to control electronic components of the hand sanitizer dispenser;
c. a counter in electronic communication with the means for dispensing, and with the microprocessor, and adapted to count each use of the means for dispensing;
d. an electronic data storage means in electronic data communication with the counter, and with the microprocessor, and adapted to receive count data from the counter and store said count data;
e. an RFID tag reader in electronic data communication with the electronic data storage means, wherein the microprocessor is adapted to instruct the RFID tag reader to transmit RFID tag data to the electronic data storage means which receives and records said data, and wherein the RFID tag data is correlated to and associated with at least one count of the counter;
f. a clock circuit wherein said clock circuit is adapted to provide a time stamp and communicate said time stamp to the electronic data storage means, the time stamp being associated by the microprocessor with a use count; and
g. a data port adapted to communicate count and RFID tag data to an external computer system;
a remote server computer adapted to communicate with the microcomputer on-board the hand sanitizer dispenser, and to receive data therefrom comprising hand sanitizer dispenser actuation event counts associated with a time stamp and with a user, wherein the remote server computer is adapted to record the data received from the hand sanitizer dispenser's microcomputer in a database and associate said data with patient-specific data selected from one or more of admittance date, release date, electronic health records, patient name, patient social security number, patient ID number, room number, bed number, attending physician ID, other caregiver ID, visitor ID, visitation dates, diagnoses data, diagnostic test data, treatment regime data, treatment outcome data, prescription data, health insurance data, emergency contact data, or pre-existing conditions data; and
a software reporting module adapted to query the database of the remote server computer and compile the query results according to one or more predetermined reporting protocols.

13. The system of claim 12, wherein the RFID reader comprises an active RFID reader, adapted to read passive RFID tags.

14. The dispenser of claim 13, wherein a passive RFID tag is readable by an RFID tag reader on-board the hand sanitizer dispenser when the passive RFID tag is a distance from the RFID tag reader of about 12 inches, 11 inches, 10 inches, 9 inches, 8 inches, 7 inches, 6 inches, 5 inches, 4 inches, 3 inches, 2 inches, and/or 1 inch.

15. The system of claim 12, wherein data communication between the hand sanitizer dispenser's microcomputer and the remote server computer is according to an HL7 compliant protocol.
